(19) United States
(12) Patent Application Publication
(10) Pub. No.: US 2014/0298696 A1
(43) Pub. Date: Oct. 9, 2014

(54) ILLUMINATED SIGN

(71) Applicant: Screen Sign Arts Limited, Christchurch (NZ)

(72) Inventor: Richard Stuart Hunter, Christchurch (NZ)

(73) Assignee: Screen Sign Arts Limited, Christchurch (NZ)

(21) Appl. No.: 14/354,825

(22) PCT Filed: Oct. 29, 2012
(86) PCT No.: PCT/NZ2012/000197

§ 371 Date: Apr. 28, 2014

(30) Foreign Application Priority Data
Oct. 27, 2011 (NZ) 596031
Nov. 29, 2011 (NZ) 596752

(51) Int. Cl. G09F 13/18

(52) U.S. Cl. CPC G09F 13/18; G09F 2013/1804
USPC 40/546

(57) ABSTRACT

An illuminated sign which includes a single or double sided photometric lens one or both sides of which have in juxtaposition therewith a graphics panel. The photometric lens has one edge lit by a strip of light emitting diodes (LED's) and the lens(es) is(are) adapted to spread the LED's light evenly across the graphics panel and through a clip-on frame for the photometric lens and graphics panel(s) which frame can provide edge light distribution for the sign. The photometric lens can also be fitted as an illumination source in an existing exit or the like sign to produce illumination for the existing exit or the like sign.

### TECHNICAL FIELD

The invention relates to signage and particularly to an illuminated sign such as those used for indicating a point of entry to or exit from a building, for example an illuminated building exit sign.

### BACKGROUND ART

At present, particularly in New Zealand, there are available on the market and in use different sizes and constructions of sign for indicating points of entry to and exit from a building.

Typically an exit sign is a device in a public facility (such as a building, aircraft or boat) denoting the location of an emergency exit used to guide people to the closest exit in case of fire or other emergency. Most relevant building codes (fire, building, health or safety) require exit signs to be permanently lit. Exit signs are designed to be absolutely unmistakable and understandable to anyone.

Many exit signs around the world are in pictogram form, with or without a text supplement. The signs often include a white reflector plate to aid illumination but the inclusion of such a plate adds to cost and manufacturing difficulties. There has been a shift towards the adoption of such exit signs in recent decades. A small minority of nations adhere to the requirement that exit signs show the word “EXIT” (or the same or similar word in another language).

Since visibility can be reduced in a fire, due to smoke or failure of electric lighting, the sign is often permanently illuminated, usually by one of:
Radioluminescence, (traser), self-luminous, where a phosphor coating inside a glass tube glows due to the beta decay of a radioactive material in the tube. Radioluminescence exit signs are prohibited in some US installations.
Photoluminescence (‘glow in the dark’), Phosphorescence, where light is absorbed from the surroundings and slowly re-emitted.
Electric light, with a local rechargeable power source.
Electric light, with the building's emergency lighting circuits providing back-up power from a UPS and/or a generator in case normal power fails.

A number of the known signs have inherent limitations for example there is a significant cost in running standard incandescent bulbs which over time can fail with a resultant loss in their usefulness.

An object of the invention is to provide an illuminated sign which overcomes problems associated with known signs and which at least offers consumers a useful alternative choice.

Further objects and advantages of the invention will become apparent from the following description which is given by way of example only.

### SUMMARY OF THE INVENTION

According to a first aspect of the invention there is provided an illuminated sign including a single or double sided photometric lens one or both sides of which have in juxtaposition therewith a graphics panel, the photometric lens has one edge lit by a strip of light emitting diodes (LED's) and the lens(es) is(are) adapted to spread the LED's light evenly across the graphics panel and through a clip-on frame for the photometric lens and graphics panel(s) which frame provides edge light distribution for the sign.

The photometric lens preferably has in its upper edge a series of cut-outs into which LED's of the LED strip fit when the sign is assembled.

The illuminated sign can have a housing along its upper edge which covers the LED strip and its connecting wires and in which is mounted electronics which run the LED's and a power source for the electronics and LED's.

The graphics panel can include a pictogram or words as required.

A dot matrix which forms the photometric design is printed on at least one side of an acrylic blade panel and a special ink system is used which allows the natural reflection of light through both surfaces, but without producing any major shadowing through both surfaces, when in contact with the graphic panels.

According to another aspect of the invention there is provided a single or double sided photometric lens for illuminating a sign, the photometric lens being adapted to be placed in juxtaposition with a graphics panel, the photometric lens has one edge lit by a strip of light emitting diodes (LED's) and the lens(es) is(are) adapted to spread the LED's light evenly across the graphics panel and through a frame for the photometric lens and graphics panel(s).

The frame can provide edge light distribution for the sign.

Further aspects of the invention which should be considered in all its novel aspects will become apparent from the following description which is given by way of example only.

### DESCRIPTION OF THE DRAWING

An example of the invention will now be described with reference to the accompanying drawing in which:

FIG. 1 is a front view of a photometric lens design for an example of illuminated sign according to the invention;

FIG. 2 is a side view of the sign shown in FIG. 1;

FIG. 3 is a perspective view of the sign shown in FIGS. 1 and 2;

FIG. 4 is a top view of the sign shown in FIGS. 1 to 3;

FIG. 5 is a perspective view, exploded apart, of a frame and a double sided photometric lens for the sign shown in FIGS. 1 to 4;

FIG. 6 is a edge view of the photometric lens shown in FIG. 5;

FIG. 7 is a top view of an LED strip for use with the photometric lens shown in FIG. 5;

FIG. 8 is a profile edge view of the edge of the lens; and

FIG. 9 shows a perspective view of an example of graphics panel for the sign shown in FIGS. 1 and 3 with the frame shown in FIG. 5 fitted thereto.

### DESCRIPTION OF THE EXAMPLES

Examples of the invention will now be described with reference to an illuminated exit sign incorporating a pictogram of a running person. It is to be appreciated that the features of the illuminated sign can be incorporated into a variety of different forms of signage as and if required including the upgrade of existing signage.

In the following description of the example with reference to the drawing similar integers will be referred to using the same reference numbers in the different figures.

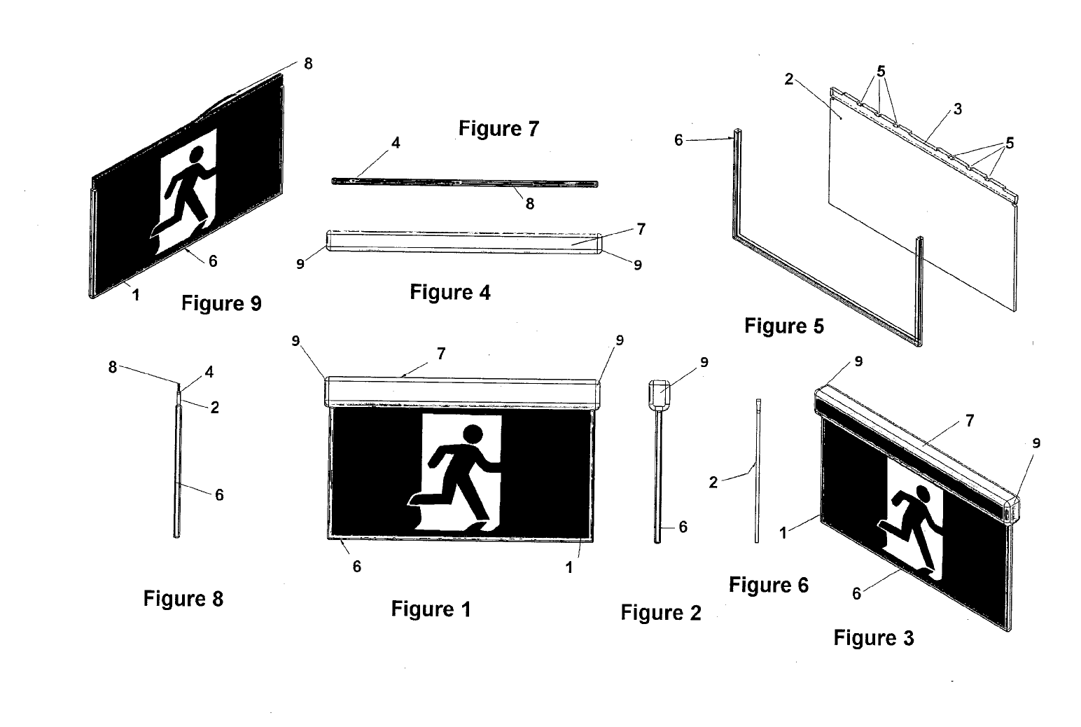

In FIGS. 1 to 4 is shown a double sided illuminated sign including a graphics panel 1 on each side of a photometric lens 2 (shown in FIGS. 5 and 6). In an alternative construction (not shown) it is envisaged that for other sign configurations if need be both sides of the lens can be printed or etched with a photometric image. In the example the lens 2 has in juxtaposition therewith graphics panels on each side and it is envisaged that for a single sided illuminated sign a graphics panel 1 would be placed on only one side of the lens 2.

The dot matrix which forms the photometric design is printed on one side of an acrylic blade lens panel 2 and a special ink application method is used which allows the natural reflection of light through both surfaces of the lens panel 2. In practice a pigment is included to tint a clear ink so that when printed or etched onto the panel the tint aids light being reflected from within the panel 2 without producing any major shadowing when in contact with a graphic panel(s). The pigmented ink can be applied in one pass through a polyester or the like mesh and stencil so that in the one pass a measured build up of the ink is applied to the surface of the panel 2.

The photometric lens 2 has one edge 3 lit by a strip of light emitting diodes (LED's) 4. The photometric lens 2 preferably has in its upper edge 5 a series off cut-outs (shown in FIG. 5) into which LED's of the LED strip 4 (shown in FIGS. 7 and 9) are fitted when the sign is assembled.

A clip-on frame 6 (shown in detail in FIG. 5) which can be three sided for a rectangular or square sign is adapted to provide edge light distribution for the sign when the photometric lens 2 and graphics panel 1 are lit by the strip LED 4. The number of sides for the clip-on frame depends on the shape of the sign.

The photometric dot matrix pattern which in the example is on one side of the lens is designed to spread the LED's light evenly across the graphics panels 1 and through the edge of the clip on frame 6.

The illuminated sign of the example has a housing 7 forming its upper edge which housing 7 covers the LED strip 4 and its connecting wires 8 (FIG. 9). The housing 7 has mounted therein the electronics which power the LED's and house a power source for the electronics and LED's. The housing 7 can be a metal or plastics extrusion the ends of which are closed by end caps 9 (shown in FIGS. 1 to 4).

The graphics panels 1 can include a pictogram or words as required.

In an alternative construction the photometric lens shown in FIG. 5 (with or without the clip on frame 6) and shown in FIGS. 6 to 9 (without the graphics panel 1) can be fitted as an illumination source in an existing exit or the like sign to produce illumination for the existing exit or the like sign.

Where in the foregoing description particular mechanical or the like integers are described it is envisaged that their mechanical equivalents can be substituted as if they were described herein.

Thus by this invention there is provided an even distribution of light over an illuminated sign with no hot spots or dark areas on the sign.

Particular examples of the invention have been described and it is envisaged that improvements can take place without departing from the scope of the attached claims.

1. An illuminated sign including a single or double sided photometric lens one or both sides of which have in juxtaposition therewith a graphics panel, the photometric lens has one edge lit by a strip of light emitting diodes (LED's) and the lens(es) is(are) adapted to spread the LED's light evenly across the graphics panel and through a clip-on frame for the photometric lens and graphics panel(s) which frame provides edge light distribution for the sign.

2. The illuminated sign as claimed in claim 1 wherein the photometric lens has in its upper edge a series of cut-outs into which LED's of the LED strip fit when the sign is assembled.

3. The illuminated sign as claimed in claim 1 wherein the sign has a housing along its upper edge which covers the LED strip and its connecting wires and in which housing is mounted electronics which run the LED's and a power source for the electronics and LED's.

4. The illuminated sign as claimed in claim 1 wherein the graphics panel includes a pictogram or word(s).

5. The illuminated sign as claimed in claim 1 wherein a dot matrix which forms the photometric design is printed on one side of an acrylic blade panel and in which a special ink system is used which allows the natural reflection of light through both surfaces while not producing any shadowing through both surfaces, when in contact with the graphic panels.

6. The illuminated sign as claimed in claim 5 wherein a pigment is included to tint a clear ink so that when it is printed onto the blade panel the tint aids light being reflected from within the panel.

7. The illuminated panel as claimed in claim 6 wherein the pigmented ink is applied in one pass through a polyester or the like mesh and stencil so that in the one pass a measured build up of the ink is applied to the surface of the blade panel.

8. The illuminated panel as claimed in claim 7 wherein the dot matrix pattern is produced by a screen formed from polyester mesh which has a mesh count of about 120 strands each way to produce the required dot matrix pattern.

9. (canceled)

10. A single or double sided photometric lens for illuminating a sign, the photometric lens being adapted to be placed in juxtaposition with a graphics panel, the photometric lens has one edge lit by a strip of light emitting diodes (LED's) and the lens(es) is(are) adapted to spread the LED's light evenly across the graphics panel and through a frame for the photometric lens and graphics panel(s).

11. The single or double sided photometric lens as claimed in claim 10 wherein the frame can provide edge light distribution for the sign.

12. The single or double sided photometric lens as claimed in claim 11 wherein the frame is an existing exit or the like sign.

13. (canceled)
